(19) United States
(12) Patent Application Publication
(10) Pub. No.: US 2010/0209332 A1
(43) Pub. Date: Aug. 19, 2010

(54) Nonaqueous Chlorine Dioxide-Generating Compositions and Methods Related Thereto

(75) Inventors: Linda Hratko, Colonia, NJ (US); Barry Keven Speronello, Belle Mead, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/702,743

(22) Filed: Feb. 9, 2010

Related U.S. Application Data
(60) Provisional application No. 61/153,847, filed on Feb. 19, 2009.

(51) Int. Cl. C01B 11/02

(52) U.S. Cl. 423/477

(57) ABSTRACT

A method for generating chlorine dioxide is disclosed in which chlorine dioxide generation is activated with a dry polar material. A system for generating chlorine dioxide is also disclosed, as well as compositions useful in the system and method.

### CROSS-REFERENCE TO RELATED APPLICATIONS

This application claims the benefit pursuant to 35 U.S.C.§119(e) of U.S. Provisional Application No. 61/153,847, filed Feb. 19, 2009, which is hereby incorporated herein by reference in its entirety.

### BACKGROUND

Chlorine dioxide (ClO₂) is a neutral compound of chlorine in the +IV oxidation state. It disinfects by oxidation; however, it does not chlorinate. It is a relatively small, volatile, and highly energetic molecule, and a free radical even in dilute aqueous solutions. Chlorine dioxide functions as a highly selective oxidant due to its unique, one-electron transfer mechanism in which it is reduced to chlorite (ClO₂⁻). Free molecular chlorine dioxide in solution is an effective agent for the control of microorganisms and biological film deposits.

There are a number of methods of preparing chlorine dioxide by reacting chlorite ions in water to produce chlorine dioxide gas dissolved in water. The traditional method for preparing chlorine dioxide involves reacting sodium chlorite with gaseous chlorine (Cl₂(g)), hypochlorous acid (HOCl), or hydrochloric acid (HCl). The reactions are:

2NaClO₂+Cl₂(g)→2ClO₂(g)+2NaCl [1a]

2NaClO₂+HOCl→2ClO₂(g)+NaCl+NaOH [1b]

5NaClO₂+4HCl→ClO₂(g)+5NaCl+2H₂O [1c]

Reactions [1a] and [1b] proceed at much greater rates in acidic medium, so substantially all traditional chlorine dioxide generation chemistry results in an acidic product solution having a pH below 3.5. Also, because the kinetics of chlorine dioxide formation are high order in chlorite anion concentration, chlorine dioxide generation is generally done at high concentration (>1000 ppm), which must be diluted to the use concentration for application.

Chlorine dioxide can also be prepared from chlorate anion by either acidification or a combination of acidification and reduction. Examples of such reactions include:

2NaClO₃+4HCl→2ClO₂+Cl₂+2H₂O+2NaCl [2a]

2HClO₃+H₂C₂O₄→2ClO₂+2CO₂+2H₂O [2b]

2NaClO₃+H₂SO₄+SO₂→2ClO₂+2NaHSO₄ [2c]

At ambient conditions, all reactions require strongly acidic conditions; most commonly in the range of 7-9 N. Heating of the reagents to higher temperature and continuous removal of chlorine dioxide from the product solution can reduce the acidity needed to less than 1 N. Chlorine dioxide has also been produced by reacting chlorite ions with organic acid anhydrides.

A method of preparing chlorine dioxide in situ uses a solution referred to as “stabilized chlorine dioxide.” Stabilized chlorine dioxide solutions contain little or no chlorine dioxide, but rather, consist substantially of sodium chlorite at neutral or slightly alkaline pH. Addition of an acid to the sodium chlorite solution activates the sodium chlorite, and chlorine dioxide is generated in situ in the solution. The resulting chlorine dioxide-containing solution is acidic. Typically, the extent of sodium chlorite conversion to chlorine dioxide is low, and a substantial quantity of sodium chlorite remains in the solution.

Chlorine dioxide solutions have been produced from solid mixtures, including powders, granules, and solid compacts such as tablets and briquettes, which are comprised of materials that will generate chlorine dioxide gas when contacted with liquid water. See, for instance, commonly-assigned U.S. Pat. Nos. 6,432,322, 6,699,404, and 7,182,883, and U.S. Pat. Publication Nos. 2006/0169949 and 2007/0172412. Chlorine dioxide generating compositions, which are comprised of materials that will generate chlorine dioxide gas upon contact with water vapor, are also known. See, for instance, commonly-assigned U.S. Pat. Nos. 6,077,495, 6,294,108, and 7,220,367. U.S. Pat. No. 6,046,243 discloses composites of chlorite salt dissolved in a hydrophilic material and an acid releasing agent in a hydrophobic material. The composite generates chlorine dioxide upon exposure to moisture. Commonly-assigned U.S. Pat. Publication No. 2006/0024369 discloses a chlorine-dioxide composite comprising a chlorine dioxide-generating material integrated into an organic matrix. Chlorine dioxide is generated when the composite is exposed to water vapor or electromagnetic energy.

Chinese Patent Publication CN1104610 discloses a method of preparing a chlorine dioxide-forming composition by encapsulating sodium chlorite in Chinese wax, stearic acid (a saturated fatty acid that is a waxy solid), bees wax or paraffin wax and combining this composition with dry tartaric acid or oxalic acid particles. Contacting this mixture with water results in chlorine dioxide production.

U.S. Pat. No. 7,273,567 describes a method of preparing chlorine dioxide from a composition comprising a source of chlorite anions and an energy-activatable catalyst. Exposure of the composition to the appropriate electromagnetic energy activates the catalyst which in turn catalyzes production of chlorine dioxide gas.

All of the methods noted above rely upon water (liquid or vapor) or electromagnetic energy for the generation of chlorine dioxide. A method for generating chlorine dioxide that does not rely on water or electromagnetic energy would advance the art.

### BRIEF SUMMARY

Provided is a method for preparing chlorine dioxide in a dry environment. That is, chlorine dioxide-generating compositions containing dry components that can react to form chlorine dioxide are activated to generate chlorine dioxide in the absence of water, water vapor and an electromagnetic-energy-activatable catalyst. The activator is a polar material.

Accordingly, a method for producing chlorine dioxide comprising contacting a chlorine dioxide-generating composition with a dry polar material is provided. In one aspect, the method comprises contacting a chlorine dioxide-generating composition with a dry polar material, wherein the composition is dry and comprises a dry oxy-chlorine anion source, a dry acid source, and an optional dry electron acceptor source, and the polar material is a liquid; and wherein the polar material activates production of chlorine dioxide from the chlorine-dioxide-generating composition.

In another aspect, the method comprises contacting a chlorine dioxide-generating composition with a polar material, wherein the composition is dry and comprises a dry oxy-chlorine anion source, a dry acid source, an optional dry electron acceptor source, and a water-impervious matrix, and the polar material is dry; and wherein the polar material activates production of chlorine dioxide from the chlorine-dioxide-generating composition.

In another aspect, the method comprises contacting a chlorine dioxide-generating composition with a polar material, wherein the composition is dry and comprises a dry oxy-chlorine anion source, a dry acid source, an optional dry electron acceptor source, and a water-impervious matrix, and the polar material comprises a material amount of water; and wherein the polar material activates production of chlorine dioxide from the chlorine-dioxide-generating composition.

In certain embodiments of the method, the polar material is selected from the group consisting of alcohol, organic acid, aldehyde, glycerine, and combinations thereof In exemplary embodiments, the polar material is a dry polar liquid selected from the group consisting of: 1-10 carbon aliphatic alcohols, 2-10 carbon aliphatic aldehydes, 3-10 carbon aliphatic ketones, 1-10 carbon aliphatic carboxylic acids, esters of 1-9 carbon alcohols with 1-9 carbon acids wherein the total number of carbon atoms in the ester is 2-10, diols, ethylene glycol, diethylene glycol, triethylene glycol, tetraethylene glycol, pentaethylene glycol, propylene glycol, glycerine, acetone, acetonitrile, N,N-dimethylacetamide, N,N-dimethylformamide, dimethyl sulfoxide, hexamethylphosphoric triamide, isobutyl methyl ketone, 1-methyl-2-pyrrolidinone, nitromethane, propylene carbonate, pyridine, sulfolane, and combinations thereof.

In certain embodiments of the method, the dry oxy-chlorine anion source, the dry acid source, and the optional dry electron acceptor source are in the form of a particulate precursor of chlorine dioxide. The dry oxy-chlorine anion source can be selected from the group consisting of an alkali metal chlorite salt, an alkaline earth metal chlorite salt, and a combination of alkali metal chlorite salts and alkaline earth metal chlorite salt. The dry acid source can be selected from the group consisting of inorganic acid salts, ion exchange resins, molecular sieves, and organic acids. In exemplary embodiments, the dry acid source can selected from the group consisting of sodium acid sulfate, potassium acid sulfate, sodium dihydrogen phosphate, and potassium dihydrogen phosphate. In certain embodiments, the dry acid source is sodium acid sulfate.

In certain embodiments of the method, the first component comprises a dry electron acceptor source and the source is selected from the group consisting of dichloroisocyanuric acid, sodium dichloroisocyanurate sodium dichloroisocyanurate dihydrate, trichlorocyanuric acid, sodium hypochlorite, potassium hypochlorite, calcium hypochlorite, bromochlorodimethylhydantoin, and dibromodimethylhydantoin. In exemplary embodiments, the dry electron acceptor source is dichloroisocyanuric acid.

In certain embodiments of the method wherein the composition comprises a water-impervious matrix, the dry oxy-chlorine anion source, the dry acid source, and the optional dry electron acceptor source are a particulate precursor of chlorine dioxide contained within the matrix. In some embodiments, individual particles of the particulate precursor comprise a coat of matrix and the first component is particulate. In some embodiments, the matrix is selected from the group consisting of a hydrophobic solid, a hydrophobic fluid, and combinations thereof. A hydrophobic solid can be selected from the group consisting of: paraffin wax, microcrystalline wax, polyethylene wax, polypropylene wax, polyethylene glycol wax, Fischer-Tropsch wax, and combinations thereof. A hydrophobic fluid is selected from the group consisting of petroleum oil, petrolatum, light mineral oil, heavy mineral oil, and combinations thereof. In certain embodiments, the water-impervious matrix comprises at least one of petrolatum, mineral oil, and paraffin wax and the polar material is selected from the group consisting of glycerine, propylene glycol, isopropanol, butyl alcohol, octanoic acid, and combinations thereof.

Further provided is a two-component system for preparing a chlorine-dioxide generating composition. In one aspect, the system comprises a first component comprising a dry oxy-chlorine anion source, a dry acid source, and an optional dry electron acceptor source; and a second component comprising a polar material, wherein the first and second components are dry and the second component is a liquid; and wherein combination of the first and second components yields a chlorine dioxide-generating composition.

In another aspect, the system comprises a first component comprising a dry oxy-chlorine anion source, a dry acid source, an optional dry electron acceptor source, and a water-impervious matrix; and a second component comprising a polar material, wherein the first and second components are dry; and wherein combination of the first and second components yields a chlorine dioxide-generating composition.

In another aspect, the system comprises a first component comprising a dry oxy-chlorine anion source, a dry acid source, an optional dry electron acceptor source, and a water-impervious matrix; and a second component comprising a polar material and a material amount of water, wherein the first component is dry; and wherein combination of the first and second components yields a chlorine dioxide-generating composition.

In certain embodiments of the two-component system, the polar material is selected from the group consisting of alcohol, organic acid, aldehyde, glycerine, and combinations thereof. In exemplary embodiments, the polar material is a dry polar liquid selected from the group consisting of: 1-10 carbon aliphatic alcohols, 2-10 carbon aliphatic aldehydes, 3-10 carbon aliphatic ketones, 1-10 carbon aliphatic carboxylic acids, esters of 1-9 carbon alcohols with 1-9 carbon acids wherein the total number of carbon atoms in the ester is 2-10, diols, ethylene glycol, diethylene glycol, triethylene glycol, tetracthylene glycol, pentaethylene glycol, propylene glycol, glycerine, acetone, acetonitrile, N,N-dimethylacetamide, N,N-dimethylformamide, dimethyl sulfoxide, hexamethylphosphoric triamide, isobutyl methyl ketone, 1-methyl-2-pyrrolidinone, nitromethane, propylene carbonate, pyridine, sulfolane, and combinations thereof.

In certain embodiments of the two-component system, the dry oxy-chlorine anion source, the dry acid source, and the optional dry electron acceptor source are in the form of a particulate precursor of chlorine dioxide. The dry oxy-chlorine anion source can be selected from the group consisting of an alkali metal chlorite salt, an alkaline earth metal chlorite salt, and a combination of alkali metal chlorite salts and alkaline earth metal chlorite salt. The dry acid source can be selected from the group consisting of inorganic acid salts, ion exchange resins, molecular sieves, and organic acids. In exemplary embodiments, the dry acid source can selected from the group consisting of sodium acid sulfate, potassium acid sulfate, sodium dihydrogen phosphate, and potassium dihydrogen phosphate. In certain embodiments, the dry acid source is sodium acid sulfate.

In certain embodiments of the system, the the first component comprises a dry electron acceptor source and the source is selected from the group consisting of dichloroisocyanuric acid, sodium dichloroisocyanurate sodium dichloroisocyanurate dihydrate, trichlorocyanuric acid, sodium hypochlorite, potassium hypochlorite, calcium hypochlorite, bromochlorodimethylhydantoin, and dibromodimethylhydantoin. In exemplary embodiments, the dry electron acceptor source is dichloroisocyanuric acid.

In certain embodiments of the two-component system wherein the first component comprises a water-impervious matrix, the dry oxy-chlorine anion source, the dry acid source, and the optional dry electron acceptor source are a particulate precursor of chlorine dioxide contained within the matrix. In some embodiments, individual particles of the particulate precursor comprise a coat of matrix and the first component is particulate. In some embodiments, the matrix is selected from the group consisting of a hydrophobic solid, a hydrophobic fluid, and combinations thereof. A hydrophobic solid can be selected from the group consisting of paraffin wax, microcrystalline wax, polyethylene wax, polypropylene wax, polyethylene glycol wax, Fischer-Tropsch wax, and combinations thereof. A hydrophobic fluid is selected from the group consisting of petroleum oil, petrolatum, light mineral oil, heavy mineral oil and combinations thereof. In certain embodiments, the water-impervious matrix comprises at least one of petrolatum, mineral oil and paraffin wax and the polar material is selected from the group consisting of glycerine, propylene glycol, isopropanol, butyl alcohol, octanoic acid and combinations thereof.

It is to be understood that both the foregoing general description and the following detailed description are exemplary and explanatory and are intended to provide further explanation of the subject matter as claimed.

### DETAILED DESCRIPTION

Methods of preparing chlorine dioxide in water or aqueous media are well known in the art. Methods of preparing chlorine dioxide upon exposure to water vapor are also known. Preparing chlorine dioxide in the absence of water or water vapor, using an electromagnetic-energy-activatable catalyst to activate generation of chlorine dioxide from an oxy-chlorine anion source, is also known. Prior to this disclosure, however, there has been no way to produce chlorine dioxide in a substantially dry or anhydrous environment, such as plastic or fluid hydrophobic matrices, or to rapidly produce chlorine dioxide in a solid matrix in the absence of electromagnetic energy. Thus, the disclosure provides in part a method of preparing chlorine dioxide in a dry or anhydrous environment, wherein none of water, water vapor, and electromagnetic energy are necessary to activate the generation of chlorine dioxide. Further provided is a system for preparing chlorine dioxide. Compositions and kits useful for practicing the method are also provided.

### DEFINITIONS

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

The term “about” will be understood by persons of ordinary skill in the art and will vary to some extent on the context in which it is used. Generally, “about” encompasses a range of values that are plus/minus 10% of a reference value. For instance, “about 25%” encompasses values from 22.5% to 27.5%.

It is understood that any and all whole or partial integers between any ranges set forth herein are included herein. With respect to any figure or numerical range for a given characteristic, a figure or a parameter from one range can be combined with another figure or a parameter from a different range for the same characteristic to generate a numerical range.

The term “chlorine dioxide-generating components” refers to an oxy-chlorine anion source, an acid source, and optionally an electron acceptor source. The electron acceptor source can be a cationic halogen source, such as chlorine. In the practice of the method, composition, and system, all of these sources are dry or anhydrous.

The term “dry,” as used herein, means a material which contains very little free water, adsorbed water, or water of crystallization. “Very little” is relative to the activation of chlorine dioxide production. Specifically, a material that contains an amount of water that does not activate a high rate of production of chlorine dioxide from chlorine dioxide-generating components under ordinary conditions, as described herein or in the art, is considered dry. More specifically, a material that does not exhaust in 24 hours the chlorine dioxide-generating potential of a given amount of chlorine dioxide-generating components is considered dry. A dry material can be solid, liquid, or gaseous. A dry material can contain water of crystallization, provided that the dry material alone does not activate generation of chlorine dioxide from a mixture comprising chlorine dioxide-generating components. Generally, dry materials have less than about 5 weight % water, less than about 1 weight % water, or less than about 0.5 weight % water.

As used herein, a “dry chlorine dioxide-generating composition” refers to a chlorine dioxide-generating composition comprising an amount of free water equal to or less than the amount of water that would exhaust the chlorine dioxide-generating potential of a given amount of the chlorine dioxide-generating composition in 24 hours.

The term “anhydrous,” as used herein, means a material that does not contain water, such as free water, adsorbed water, or water of crystallization. An anhydrous material is also dry, as defined above. However, a dry material is not necessarily anhydrous, as defined herein.

As used herein, “nonaqueous” refers generally to the condition of having little or no water, and is generally interchangeable with “dry” as used herein. Accordingly, it encompasses “anhydrous” as used herein.

The term “material amount,” as used herein, refers to an amount of free water in measurable excess of adsorbed water or water of crystallization.

The term “particulate” is defined to mean all solid materials. By way of a non-limiting example, particulates can be interspersed with each other to contact one another in some way. These solid materials include particles comprising big particles, small particles or a combination of both big and small particles.

As used herein, a “particulate precursor of chlorine dioxide” refers to an intimate mixture of chlorine dioxide-forming components that is formed into particulates. Granules of ASEPTROL (BASF, Florham Park, N.J.) are an exemplary particulate precursor of chlorine dioxide.

The term “alkali metal chlorite salt” refers to a chlorous acid salt of lithium, sodium, potassium, rubidium, or cesium.

The term “alkaline earth metal chlorite salt” refers to a chlorous acid salt of magnesium, calcium, strontium, or barium.

The term “polar material” as used herein, refers to a material which has, as a result of its molecular structure, an electrical dipole moment on a molecular scale. Most commonly, polar materials are organic materials which comprise chemical elements with differing electronegativities. Elements that can induce polarity in organic materials include oxygen, nitrogen, sulfur, halogens, and metals. Polarity can be present in a material to different degrees. A material can be considered more polar if its molecular dipole moment is large, and less polar if its molecular dipole moment is small. For example, ethanol, which supports the electronegativity of the hydroxyl over a short, 2 carbon chain can be considered relatively more polar compared to hexanol (C₆H₁₃OH) which supports the same degree of electronegativity over a 6 carbon chain. The dielectric constant of a material is a convenient measure of polarity of a material. As shown herein, a polar material useful in the method, system and composition has a dielectric constant, measured at about 18-25° C., of greater than 2.5. The term “polar material” excludes water and aqueous materials. A polar material can be a solid, a liquid, or a gas.

A “matrix,” as used herein, is a material that functions as a protective carrier of chlorine dioxide-generating components. A matrix is typically a continuous solid or fluid phase in which materials which can participate in a reaction to form chlorine dioxide are suspended or otherwise contained. The matrix can provide physical shape for the material. If sufficiently hydrophobic, a matrix can protect the materials within from contact with moisture. If sufficiently rigid, a matrix can be formed into a structural member. If sufficiently fluid, a matrix can function as a vehicle to transport the material within the matrix. If sufficiently adhesive, the matrix can provide a means to adhere the material to an inclined or vertical, or horizontal downward surface. A fluid matrix can be a liquid such that it flows immediately upon application of a shear stress, or it can require that a yield stress threshold be exceeded to cause flow. An exemplary matrix can be either a fluid, or capable of becoming fluid (e,g., upon heating) such that other components can be combined with and into the matrix (e.g., to initiate reaction to form chlorine dioxide).

The term “water-impervious matrix” refers to a hydrophobic matrix that prevents substantially pure water from penetrating therethrough. Accordingly, a water-impervious matrix is nonaqueous. However, water can penetrate through the water-impervious matrix when mixed with a polar material, such as glycerine or an alcohol. An exemplary water-impervious matrix can be permeable to chlorine dioxide gas.

The term “slightly soluble,” as used herein, refers describes the ability of one material to form a solution with a second material, wherein the maximum amount of the second material which can be combined as a solution with the first material is relatively low. For example, material B is slightly soluble in material A if the maximum amount of B that can be dissolved into A is less than 50%, less than 25%, less than 20%, or less than 15% of the final solution comprising A and B. More commonly a slightly soluble material will be able to comprise less than 10%, 9%, 8%, 7%, 6%, 5%, 4%, 3%, or 2% of the final solution, and often the maximum amount of slightly soluble material that can enter solution can be less than 1% of the final solution. Such solutions can be solids or fluid.

As used herein, an “efficacious amount” of an agent is intended to mean any amount of the agent that will result in a desired biocidal effect, a desired cosmetic effect, and/or a desired therapeutic biological effect. For instance, an efficacious amount of an agent used for surface disinfection is an amount that will result in the desired biocidal effect with one or more treatments of the surface.

As used herein, “cytotoxic” refers to the property of causing lethal damage to mammalian cell structure or function. A composition is deemed “substantially non-cytotoxic” or “not substantially cytotoxic” if the composition meets the United States Pharmacopeia (USP) biological reactivity limits of the Agar Diffusion Test of USP <87> “Biological Reactivity, in vitro,” (approved protocol current in 2007) when the active agent is present in an efficacious amount.

As used herein, “irritating” refers to the property of causing a local inflammatory response, such as reddening, swelling, itching, burning, or blistering, by immediate, prolonged, or repeated contact. For example, inflammation of the gingival tissue in a mammal is an indication of irritation to that tissue. A composition is deemed “substantially non-irritating” or “not substantially irritating” if the composition is judged to be slightly or not irritating using any standard method for assessing dermal or mucosal irritation. Non-limiting examples of methods useful for assessing dermal irritation include the use of in vitro tests using tissue-engineered dermal tissue, such as EpiDerm™ (MatTek Corp., Ashland, Mass.), which is a human skin tissue model (see, for instance, Chatterjee et al., 2006, Toxicol Letters 167: 85-94) or ex vivo dermis samples. Non-limiting examples of methods useful for mucosal irritation include: HET-CAM (hen's egg test-chorioallantoic membrane); slug mucosal irritation test; and in vitro tests using tissue-engineered oral mucosa or vaginal-ectocervical tissues. The skilled artisan is familiar with art-recognized methods of assessing dermal or mucosal irritation.

The phrase “thickened fluid composition” encompasses compositions which can flow under applied shear stress and which have an apparent viscosity when flowing that is greater than the viscosity of the corresponding aqueous chlorine dioxide solution of the same concentration. This encompasses the full spectrum of thickened fluid compositions, including: fluids that exhibit Newtonian flow (where the ratio of shear rate to shear stress is constant and independent of shear stress), thixotropic fluids (which require a minimum yield stress to be overcome prior to flow, and which also exhibit shear thinning with sustained shear), pseudoplastic and plastic fluids (which require a minimum yield stress to be overcome prior to flow), dilantant fluid compositions (which increase in apparent viscosity with increasing shear rate) and other materials which can flow under applied yield stress.

The phrase “apparent viscosity” is defined as the ratio of shear stress to shear rate at any set of shear conditions which result in flow. Apparent viscosity is independent of shear stress for Newtonian fluids and varies with shear rate for non-Newtonian fluid compositions.

A “thickener component,” as the phrase is used herein, refers to a component that has the property of thickening a solution or mixture to which it is added. A “thickener component” is used to make a “thickened fluid composition” as described above.

The term “hydrophobic” or “water-insoluble” as employed herein with respect to organic polymers refers to an organic polymer in which water is soluble to an amount less of less than 1 gram, 0.9 gram, 0.8 gram, 0.7 gram, 0.6 gram, 0.5 gram, 0.4 gram, 0.3 gram or 0.2 gram water per 100 grams of hydrophobic material at 25° C. In exemplary embodiments, a hydrophobic material will accommodate in solution less than 0.1 grams of water per 100 grams of hydrophobic material.

The term “stable,” as used herein, is intended to mean that the components used to form chlorine dioxide, i.e., the chlorine dioxide-generating components, are not substantially reactive with each other to form chlorine dioxide, until contact with an activator of chlorine dioxide production.

As used herein, “rapidly produced” refers to as used herein means that total chlorine dioxide production is obtained in less than about 7 days, less than about 8 hours, less than about 2 hours or less than about 1 hour.

Unless otherwise indicated or evident from context, preferences indicated herein apply to the entirety of the disclosure, including the two-component system and the method.

### DESCRIPTION

### I. Method

Unless otherwise specified or evident from the context, “chlorine dioxide-generating components” as used below refers to dry or anhydrous components.

The disclosure provides in part a method of preparing chlorine dioxide in the absence of water, water vapor or an electromagnetic-energy-activatable catalyst. The method comprises contacting dry or anhydrous chlorine dioxide-generating components with a dry or anhydrous polar material, wherein the polar material is capable of facilitating the reaction of a dry or anhydrous oxy-chlorine anion source to form chlorine dioxide.

In one aspect, the method can be carried out by exposing a dry or anhydrous chlorine dioxide-generating composition to a dry or anhydrous polar liquid. Specifically, a chlorine dioxide-generating composition containing a dry oxy-chlorine anion source, a dry acid source, and an optional dry electron acceptor source is exposed to a dry polar liquid. The polar liquid activates the composition, and chlorine dioxide generation begins. The resulting liquid composition is a nonaqueous composition that generates, and thus contains, chlorine dioxide. The rate at which chlorine dioxide can be generated depends upon the amount of polar liquid used and the polarity of the liquid. If the volume of polar liquid is large relative to the amount of the chlorine dioxide-generating components or the polarity of the polar liquid is great, then chlorine dioxide can be generated more rapidly. If a smaller volume of polar liquid is used or the polar liquid is only slightly polar, then the rate of chlorine dioxide generation can be slower. Of course, the total amount of chlorine dioxide that can be generated depends on the amount of oxy-chlorine anion source present in the composition. In one embodiment, the chlorine dioxide-generating composition comprises the chlorine dioxide-generating components are in the form of particulate precursor.

In another aspect, the method can be carried out by preparing a chlorine dioxide-generating matrix composition comprising a dry or anhydrous, water-impervious matrix, and dry or anhydrous chlorine dioxide-generating components. In one embodiment, the chlorine dioxide-generating components are intermixed, suspended, dispersed, or otherwise contained in the matrix, forming a system wherein the matrix is the continuous phase and the chlorine dioxide-generating components are a dispersed phase. The resulting composition can be a fluid, a semi-solid, or a solid. Semi-solid forms include gels and pastes; such forms are plastic and generally hold a shape at low shear, e.g., gravity, and flow upon the application of higher shear stress. In another embodiment, chlorine dioxide-generating components are a particulate precursor and are coated by the matrix to form a matrix composition of coated particulates.

To activate production of chlorine dioxide, the chlorine dioxide-generating matrix composition can be contacted with a polar material that is at least slightly soluble in the water-impervious matrix. The polar material can be liquid, solid, or gaseous. In some embodiments, the polar material can be a polar liquid. The dry or anhydrous chlorine dioxide-generating components can be present as a particulate precursor of chlorine dioxide, which particulate precursor is suspended or otherwise contained in the matrix. In one aspect, the polar material can be substantially dry or anhydrous. The resulting composition can therefore be a nonaqueous composition that generates (and thus contains) chlorine dioxide. In another aspect, the polar material comprises material amounts of water. In this embodiment and without wishing to be bound by theory, it is believed that the polar material performs a dual function of both activating chlorine dioxide production on its own and of facilitating transport of water through the otherwise water-impervious matrix so that water can further activate chlorine dioxide production. In this aspect, for a given quantity of polar material, the rate and/or extent of chlorine dioxide produced will usually be substantially greater than it would be in the absence of a material amount of water in the polar material. Such activation occurs while the chlorine dioxide-generating components remain substantially entirely encased in the otherwise substantially water-impervious matrix material; this mode of activation is unlike prior art methods which require that the matrix be broken, heated or otherwise removed thereby exposing the chlorine dioxide-generating components for activation by water or water vapor.

In some embodiments, a chlorine dioxide-generating matrix composition comprises one or more additional components, as described elsewhere herein. In another embodiment, the chlorine dioxide-generating matrix composition consists essentially of chlorine dioxide-generating components consisting of an oxy-chlorine anion source, an acid source, an optional electron acceptor and optionally, one or more chloride salts, and a water-impervious matrix. The chlorine dioxide-generating components can be a particulate precursor of chlorine dioxide. In exemplary embodiments, chlorine dioxide production can only be activated by contact with a polar material. That is, none of water, water vapor and electromagnetic energy are capable of activating chlorine dioxide production from the chlorine dioxide-generating matrix composition, unless water or water vapor is allowed to directly contact the chlorine dioxide-generating components (for example, if the matrix is physically broken to expose chlorine dioxide-generating particles, or the matrix is heated to above its melting temperature and is decanted or otherwise separated from the chlorine dioxide-generating components).

To prepare the composition comprising chlorine dioxide-generating components in a matrix, the chlorine dioxide-generating components are added individually, and in any order, to the matrix material. Alternatively, the chlorine dioxide-generating components are combined together to prepare a particulate precursor of chlorine dioxide. The particulate precursor can then be combined with the matrix material.

An exemplary particulate precursor employed in the practice of the method and system can be an ASEPTROL product, such ASEPTROL S-Tab2 and ASEPTROL S-Tab10. ASEPTROL S-Tab2 has the following chemical composition by weight (%): NaClO₂ (7%); NaHSO₄ (12%); sodium dichloroisocyanurate dihydrate (NaDCC) (1%); NaCl (40%); MgCl₂ (40%). Example 4 of U.S. Pat. No. 6,432,322 describes an exemplary manufacture process of S-Tab2 tablets. ASEPTROL S-Tab10 has the following chemical composition by weight (%): NaClO₂ (26%); NaHSO₄ (26%); NaDCC (7%); NaCl (20%); MgCl₂ (21%). Example 5 of U.S. Pat. No. 6,432,322 describes an exemplary manufacture process of S-Tab10 tablets.

The chlorine dioxide-generating components are optionally ground, however, they do not need to be finely ground in order to generate chlorine dioxide. Grinding a mixture of chlorine dioxide-generating components and sieving it to prepare a −40 mesh sieve fraction can be useful in many instances. However, the size of the particles is not critical, and both grinds coarser than 40 mesh and grinds finer than 40 mesh can be used to generate chlorine dioxide in the method and system. Granules of ASEPTROL products can be produced, for instance, by comminuting ASEPTROL tablets, or by dry roller compaction of the non-pressed powder of the ASEPTROL components, followed by breakup of the resultant compacted ribbon or briquettes, and then optionally screening to obtain the desired size granule.

The method of mixing the chlorine dioxide-generating components with the water-impervious matrix to prepare a composite system depends largely on the viscosity of the matrix. For a thin, low viscosity matrix, the solid components can be intermixed or suspended in the matrix by simple stirring. For more viscous matrix materials, the solid components can be mixed in using a high shear mixer, such as a screw mixer. Alternatively, a more viscous, or a solid matrix, can be heated to reduce its viscosity or to melt it and facilitate mixing with the chlorine dioxide-generating components. In one embodiment, the chlorine dioxide-generating components are homogenously dispersed in the matrix. In another embodiment, the chlorine dioxide-generating components are not homogenously dispersed.

The method of preparing matrix-coated particulates can use any method known in the art for preparing coated particulates. Such methods include, but are not limited to, prilling, spray-drying, fluid bed coating, tablet coating, magnetically-assisted impact coated (MAIC), V-blending, hot blending and the like.

In preparing the chlorine dioxide-generating matrix composition, care is take to maintain a temperature of less than about 150-160° C., to minimize thermal decomposition of the oxy-chlorine ion source. In exemplary embodiments, the temperature can be less than about 135° C., or less than about 110° C. Care can also be taken to minimize exposure of the chlorine dioxide-generating components to moist air or water. Once the chlorine dioxide-generating matrix composition is prepared, the water-impervious matrix advantageously shields the dry or anhydrous components from water or moist air, thereby minimizing or precluding premature generation of chlorine dioxide. Accordingly, the chlorine dioxide-generating matrix composition can be stable and requires no special protection from moist air, water, or aqueous media.

### II. Components

1. Chlorine Dioxide-Generating Components

Chlorine dioxide-generating components are an oxy-chlorine anion source, an acid source, and optionally, a source of an electron acceptor. As stated elsewhere herein, “chlorine dioxide-generating components” as used below refers to dry or anhydrous components. Accordingly, chlorine dioxide-generating components useful in practicing the method and system can be a dry or anhydrous oxy-chlorine anion source, a dry or anhydrous acid source, and optionally, a dry or anhydrous electron acceptor source.

Oxy-chlorine anion sources generally include chlorites and chlorates. The dry or anhydrous oxy-chlorine anion source can be an alkali metal chlorite salt, an alkaline earth metal chlorite salt, an alkali metal chlorate salt, an alkaline earth metal chlorate salt and combinations of such salts. Examples of dry or anhydrous oxy-chlorine anion sources include, but are not limited to, sodium chlorite, potassium chlorite, calcium chlorite, sodium chlorate, potassium chlorate, and calcium chlorate. The oxy-chlorine anion source in exemplary embodiments can be an alkali metal chlorite salt. Sodium chlorite is an exemplary alkali metal chlorite salt.

Acid sources useful in the method and system comprise substantially any dry or anhydrous material capable of donating protons to the chlorine dioxide generation reactions. Such acid sources include, but are not limited to, inorganic acid salts, such as sodium acid sulfate (sodium bisulfate), potassium acid sulfate, sodium dihydrogen phosphate, and potassium dihydrogen phosphate; proton ion exchange materials such as ion exchange resins and molecular sieves; organic acids, such as citric acid, acetic acid, and tartaric acid; mineral acids such as anhydrous HCl; and mixtures of acids. Acid sources can be solids, such as sodium hydrogen sulfate and citric acid; liquid acids, such as anhydrous acetic acid; or gaseous, such as HCl gas. In one embodiment, the acid source can be an inorganic acid source. Sodium acid sulfate is an exemplary inorganic acid.

The optional component, a source of an electron acceptor, provides electron acceptor molecules which can accept an electron from a chlorite ion and thereby produce neutral chlorine dioxide. Halides such as bromine and chlorine readily accept an electron from the chlorite ion. Accordingly, molecules which provide free chlorine or bromine are useful as electron acceptor sources. Exemplary sources of free chlorine or bromine include dichloroisocyanuric acid and salts thereof such as sodium dichloroisocyanurate and/or the dihydrate thereof (collectively referred to herein as NaDCCA), trichlorocyanuric acid, salts of hypochlorous acid such as sodium, potassium and calcium hypochlorite bromochlorodimethylhydantoin, dibromodimethylhydantoin, and the like. In certain embodiments, the electron acceptor can be chlorine. An exemplary source of chlorine is NaDCCA.

2. Polar Materials

Polar materials useful for activating production of chlorine dioxide in dry or anhydrous environments comprise any nonaqueous compound with a structure that is not electrically symmetrical. The electrical asymmetry of the nonaqueous compound facilitates the reaction between the dry or anhydrous oxy-chlorine anion source and a dry or anhydrous acid source to produce chlorine dioxide. One measure of the polarity of a material is its dielectric constant. Dielectric constant is defined as the ability of a material to store electrical potential energy under the influence of an electric field. It represents the ratio of the capacitance of a capacitor with the material as its dielectric to the capacitance of the same capacitor assembly with vacuum as the dielectric. Dielectric constant can be measured by several methods known to one skilled in the art. One common method is to assemble a capacitor with the material as its dielectric into a resonant electrical circuit and under an AC potential determine the resonant frequency of the circuit. As shown herein, non-aqueous materials having a dielectric constant measured at 18-25° C. of greater than 2.5 are sufficiently polar to activate chlorine dioxide production from chlorine dioxide-generating components. Useful polar materials have a dielectric constant of greater than 2.5, including 2.6, 2.7, 2.8, 2.9, 3.0, 3.1, 3.2 or greater measured at 18-25° C. In an embodiment, the polar material has a dielectric constant of at least about 3.0 measured at 18-25° C.

A polar material can be a solid, a liquid, or a gas. Exemplary polar materials include, but are not limited to, dry or anhydrous polar organic compounds, such as alcohols, organic acids, aldehydes, and the like. Regarding organic acids, it is noted that in the absence of water, an organic acid does not dissociate into protons and a conjugate base, and therefore cannot function as a proton donor (acid source). In the absence of water (dry or anhydrous), an organic acid can function as a polar material, provided its dielectric constant is greater than 2.5, 2.6, 2.7, 2.8, 2.9, 3.0, 3.1, 3.2 or greater measured at 18-25° C. In some embodiments, the polar material is dry or anhydrous and comprises an organic acid. In other embodiments, where the polar material is used to activate chlorine dioxide production from a chlorine dioxide-generating matrix composition, the polar material comprises organic acid and material amounts of water.

Polar liquids can be used to activate chlorine dioxide production of a dry or anhydrous chlorine dioxide-generating composition. Polar liquids are also useful for activating chlorine dioxide production from a chlorine dioxide-generating matrix composition. A wide variety of polar liquids can be used to initiate the formation of chlorine dioxide. The choice of polar liquid is influenced by the dry or anhydrous matrix in which the chlorine dioxide-generating components are dispersed. For this embodiment, the polar liquid must be at least slightly soluble in the matrix. Exemplary polar liquids include, but are not limited to, 1-10 carbon aliphatic alcohols; 2-10 carbon aliphatic aldehyde; 3-10 carbon aliphatic ketones; 1-10 carbon aliphatic carboxylic acids; esters of 1-9 carbon alcohols with 1-9 carbon acids in which the total number of carbon atoms in the ester is 2-10; diols such as ethylene glycol, diethylene glycol, triethylene glycol, tetraethylene glycol, pentaethylene glycol, and propylene glycol; glycerine; and dipolar aprotic solvents such as acetone, acetonitrile, N,N-dimethylacetamide, N,N-dimethylformamide, dimethyl sulfoxide, hexamethylphosphoric triamide, isobutyl methyl ketone, 1-methyl-2-pyrrolidinone, nitromethane, propylene carbonate, pyridine, and sulfolane. Alcohols, glycols and glycerine in particular are suitable solvents for initiating the formation of chlorine dioxide. Exemplary polar materials include: isopropanol, butyl alcohol, propylene glycol, glycerine and octanoic acid. Mixtures of dry polar liquids can also be used to activate a chlorine dioxide-generating composition.

Polar solids or vapors are also useful for activating chlorine dioxide production from a chlorine dioxide-generating matrix composition. The choice of polar solid or vapor is influenced by the dry or anhydrous matrix in which the chlorine dioxide-generating components are dispersed. For this embodiment, the polar solid or vapor must be at least slightly soluble in the matrix.

3. Matrices

The dry or anhydrous water-impervious matrix protects the chlorine dioxide generating components from contact with water, including water vapor, so that little, if any, chlorine dioxide is generated, absent a polar material activator. The source-of oxy-chlorine ions does not dissolve in the water-impervious matrix. In other words, when dispersed in the water-impervious matrix, the source of oxy-chlorine ions is not dissociated into anion form. Matrix materials suitable in the practice of the method and system include water-impervious solid components such as hydrophobic waxes, water-impervious fluids such as hydrophobic oils, and mixtures of hydrophobic solids and hydrophobic fluids. These water-impervious components generally do not contain substantial quantities of water and thus are generally dry. The matrix can be a single hydrophobic solid, or a single hydrophobic fluid. Alternatively, the matrix can be a mixture of hydrophobic solids, a mixture of hydrophobic fluids, or a mixture comprising both hydrophobic solids and fluids. Waxes and oils are readily miscible with one another. Accordingly, it is possible to prepare a variety of matrices from various proportions of hydrophobic waxes and hydrophobic oils. Thus, the matrix can also be a mixture of a wax and one or more oils, a mixture of an oil, and one or more waxes, or a mixture of plural waxes and plural oils. By mixing waxes and oils, it is possible to prepare a matrix having a wide variety of physical properties. A composition having a high proportion of a hard, high melting wax, such as paraffin wax, can be stiff and solid. By adding more oils to the composition, and using softer waxes, matrixes with more grease-like properties can be prepared. Matrixes having a high proportion of oil tend to be liquid. As discussed elsewhere herein, matrix materials that are fluid at temperatures of less than about 150-160° C. are suitable to minimize thermal decomposition of the oxy-chlorine ion source.

Solids useable in the compositions include animal and insect waxes; vegetable waxes; mineral waxes; petroleum waxes such as paraffin wax and microcrystalline wax; and synthetic waxes such as low molecular weight polyethylene, low molecular weight polypropylene, polyethylene glycol, and Fischer-Tropsch waxes; and silicon gels. Fluids useable in the compositions include petroleum oils and petrolatum; light and heavy minerals oils; vegetable oils: and silicon oils. Exemplary solids include paraffin wax and low molecular weight polyethylene. Exemplary fluids include petrolatum and mineral oils. Combinations of exemplary solids and exemplary fluids are also useful.

Commercially available water-impervious matrices include: VASELINE petrolatum (Unilever, Clinton, Conn.); AVAGEL mineral jelly (Avatar, University Park, Ill.), which is a mixture of paraffin wax, petrolatum and mineral oil; PLASTIBASE (Squibb, New Brunswick, N.J.) medical ointment base, which is a mixture of low molecular weight polyethylene (5%) and mineral oil (95%).

Based on the present disclosure, the skilled artisan will readily identify appropriate combinations of matrix and polar material for activating chlorine dioxide production from a chlorine dioxide-generating matrix composition. Non-limiting examples of matrix and polar material include a petrolatum matrix and glycerine as the polar material; a matrix comprising, or consisting essentially of, polyethylene and mineral oil, and glycerine as the polar material; and a matrix comprising, or consisting essentially of paraffin wax, petrolatum and mineral oil, and one or more of glycerine, octanoic acid, butyl alcohol, isopropanol and propylene glycol as the polar material.

4. Additional Components

The compositions can comprise additional, optional components, provided they are dry or anhydrous. In exemplary embodiments, all optional components are relatively resistant to oxidation by chlorine dioxide (and any other oxidizing agent present in the composition), since oxidation of composition components by chlorine dioxide will reduce the available chlorine dioxide for oxidation. “Relatively resistant” means that in the time scale of preparing and using the chlorine dioxide-containing composition in an application, the function of the optional component is not unacceptably diminished, and the composition retains a satisfactory level of efficacy/potency with respect to the chlorine dioxide (and other oxidizing agents if present). For applications where the chlorine dioxide-containing composition can contact biological tissue and/or materials, exemplary optional components do not contribute substantially to cytoxicity and/or irritation, thus the composition remains substantially non-cytotoxic and/or substantially non-irritating.

The addition of inorganic components to chlorine dioxide-generating components can in some instances enhance the formation of chlorine dioxide. Inorganic components which are useful in the composition include calcium chloride, calcium sulfate, calcium phosphate, sodium chloride, sodium sulfate, calcium phosphate, aluminum phosphate, magnesium phosphate, ferric sulfate, ferric phosphate or zinc phosphate, silica-alumina gel, silica-magnesia gel, silica-zirconia gel, or silica gel, and various clays. The selected additional inorganic components are mixed with an oxy-chlorine anion source, an acid source, and an option source of an electron acceptor to form a mixture. The mixture can be tableted and/or ground to prepare a particulate precursor of chlorine dioxide. Pore formers can facilitate humidity intrusion into the composition. Thus, in some embodiments, the chlorine dioxide-generating components and composition exclude pore formers. Pore formers include some of these inorganic components such as swelling inorganic clays and silica gel, as well as other materials, such as diatomaceous earth

Thickener components can be useful in some applications. Thickeners can include matrix components having relatively high viscosity, such as polyethylene wax added to a mineral oil matrix. Thickeners also include clays and other fine particle size particulate additives, like LAPONITE (Southern Clay Products, Gonzales, Tex.), attapulgite, bentonite, VEEGUM (R.T. Vanderbilt Co., Norwalk, Conn.), colloidal silica, colloidal alumina, calcium carbonate, and the like.

Additional oxidizing agents can be included. Exemplary oxidizing agents include alkali metal percarbonates (such as sodium percarbonate), carbamide peroxide, sodium perborate, potassium persulfate, calcium peroxide, zinc peroxide, magnesium peroxide, hydrogen peroxide complexes (such as a PVP-hydrogen peroxide complex), hydrogen peroxide, and combinations thereof.

Compositions intended for oral cosmetic and/or therapeutic applications can comprise components that include, but are not limited to, sweeteners, flavorants, coloring agents and fragrances. Sweeteners include sugar alcohols. Flavoring agents include, e.g., natural or synthetic essential oils, as well as various flavoring aldehydes, esters, alcohols, and other materials. Coloring agents include a colorant approved for incorporation into a food, drug, or cosmetic by a regulatory agency, such as, for example, FD&C or D&C pigments, and dyes approved by the FDA for use in the United States.

Other optional components for a composition intended for oral cosmetic and/or therapeutic use include: antibacterial agents (in addition to chlorine dioxide), enzymes, malodor controlling agents (in addition to chlorine dioxide), cleaning agents, such as phosphates, antigingivitis agents, antiplaque agents, antitartar agents, anticaries agents, such as a source of fluoride ion, antiperiodontitis agents, nutrients, antioxidants, and the like.

Optional components for a composition intended for topical disinfectant of a hard surface include: fragrance; coloring agent, such as a dye or pigment; surfactants; cleaning agents such as sodium lauryl sulfate; and the like. For topical disinfectant of a biological tissue, optional ingredients include: fragrance; coloring agents; local anesthetics such as menthol, chloroform, and benzocaine; emollients or moisturizers; analgesics; cleaning agents such as sodium lauryl sulfate; antibacterial agents (in addition to chlorine dioxide); malodor controlling agents (in addition to chlorine dioxide); bioadhesive polymers, such as polycarbophil, polyvinylprrolidone, or a mixture thereof; and the like.

### III. Uses of Composition

In general, chlorine dioxide-containing compositions can be advantageously employed in antimicrobial, in deodorization, and in antiviral processes including germicidal and disinfecting formulations. Chlorine dioxide-generating compositions are effective to destroy, disable, or render harmless a wide variety of microorganisms. Such microorganisms include bacteria, fungi, spores, yeasts, molds, mildews, protozoans, and viruses.

Accordingly, chlorine dioxide-containing compositions resulting from the method are useful in reducing microbial or viral populations on surfaces or objects, in liquids and gases, on the skin of humans and animals, on medical equipment, and so forth. Chlorine dioxide-containing compositions are also useful in reducing odors. The chlorine dioxide-containing composition can be useful for sanitizing and deodorizing clothes in a non-aqueous solvent process (i.e., dry cleaning). Chlorine dioxide-containing compositions can be utilized in cleaning and sanitizing applications relating to the food industry, hospitality industry, medical industry, and so forth. For example, industrial and commercial applications in which the chlorine dioxide-containing compositions find use include ware wash machines and dishware, cooling towers, pools, spas, fountains, industrial process waters, boilers, medical environments, and so forth. A particularly advantageous use for a chlorine dioxide-containing composition can be as an antimicrobial lubricant, used for example with food processing equipment, comprising a matrix component having a grease-like lubricating character and which contains and releases chlorine dioxide. In one embodiment, an antimicrobial lubricant comprises granules of ASEPTROL contained within a petrolatum matrixm which can be activated by glycerine.

Chlorine dioxide-containing compositions can be employed in veterinary products for use on mammalian skin including teat dips, lotions or pastes; skin disinfectants and scrubs, mouth treatment products, foot or hoof treatment products such as treatments for hairy hoof wart disease, ear and eye disease treatment products, post- or pre-surgical scrubs, disinfectants, sanitizing or disinfecting of animal enclosures, pens, veterinarian treatment areas (inspection tables, operation rooms, pens, and so forth,), and so forth. Chlorine dioxide-containing compositions can also be used to reduce microbes and odors in animal enclosures, in animal veterinarian clinics, animal surgical areas, and to reduce animal or human pathogenic (or opportunistic) microbes and viruses on animals and animal products such as eggs. Chlorine dioxide-containing compositions can be used for the treatment of various foods and plant species to reduce the microbial populations on such items, treatment of manufacturing or processing sites handling such species. Chlorine dioxide-containing compositions can be employed in cosmetic and/or therapeutic applications including wound care, oral care, toenail/fingernail care including toenail/fingernail antifungal care, periodontal disease treatment, caries prevention, tooth whitening, and hair bleaching. It is contemplated that a nonaqueous chlorine dioxide-containing composition comprising a water-impervious matrix that can function as an emollient will beneficially be an antimicrobial skin emollient.

The amount of chlorine dioxide in a composition will relate to the intended use of the composition. The skilled artisan can readily determine the appropriate amount or amount range of chlorine dioxide to be efficacious for a given use. Generally, compositions useful in the practice of the method comprise at least about 5 parts-per-million (ppm) chlorine dioxide, at least about 20 ppm, or at least about 30 ppm. Typically, the amount of chlorine dioxide can be up to about 2000 ppm up to about 700 ppm, up to about 500 ppm, or up to about 200 ppm. In certain embodiments, the chlorine dioxide concentration ranges from about 5 to about 700 ppm, from about 20 to about 500 ppm, or from about 30 to about 200 ppm chlorine dioxide. In one embodiment, the composition comprises about 30 to about 40 ppm chlorine dioxide. In one embodiment, the composition comprises about 30 ppm chlorine dioxide. In another embodiment, the composition comprises about 40 ppm chlorine dioxide.

For applications of the chlorine dioxide-containing composition that involved contact with biological tissue or material, exemplary composition can be substantially non-cytotoxic and/or substantially non-irritating. As used herein, “biological tissue” refers to an animal tissue, such as mammalian tissue, including one or more of: mucosal tissue, epidermal tissue, dermal tissue, and subcutaneous tissue (also called hypodermis tissue). Mucosal tissue includes buccal mucosa, other oral cavity mucosa (e.g., soft palate mucosa, floor of mouth mucosa and mucosa under the tongue), vaginal mucosa and anal mucosa. These tissues are collectively referred to herein as “soft tissue.” Biological tissue can be intact or can have one or more incisions, lacerations or other tissue-penetrating opening. As used herein, “biological material” includes, but is not limited to, tooth enamel, dentin, fingernails, toe nails, hard keratinized tissues and the like, found in animals, such as mammals.

For compositions comprising an oxidizing agent consisting of chlorine dioxide, cytotoxicity results predominantly from the presence of oxy-chlorine anions. Accordingly, a composition comprising chlorine dioxide that comprises zero milligram (mg) oxy-chlorine anion per gram composition to no more than about 0.25 mg oxy-chlorine anion per gram composition, from zero to 0.24, 0.23, 0.22, 0.21, or 0.20 mg oxy-chlorine anion per gram composition, from zero to 0.19, 0.18, 0.17, 0.16, 0.15, 0.14, 0.13, 0.12, 0.11, or 0.10 mg oxy-chlorine anion per gram composition, or from zero to 0.09, 0.08, 0.07, 0.06, 0.05 or 0.04 mg oxy-chlorine anion per gram composition, absent other constituents that contribute to cytotoxicity, is substantially non-cytotoxic. One of skill in the art can readily determine empirically whether a given composition has a sufficiently low oxy-chlorine concentration by determining if the formulation is cytotoxic using USP biological reactivity limits of the Agar Diffusion Test of USP <87> “Biological Reactivity, in vitro,” (approved protocol current in 2007).

Biological tissue irritation can result from extremes of pH, both acidic and basic. To minimize biological tissue irritation by a chlorine dioxide-containing composition, the composition has a pH of at least 3.5. In exemplary embodiments, the composition has a pH of at least 5, or greater than about 6. In certain embodiments, the pH ranges from about 4.5 to about 11, from about 5 to about 9, or greater than about 6 and less than about 8. In one embodiment, the pH can be about 6.5 to about 7.5. The concentration of oxy-chlorine anions is not believed to contribute to biological tissue irritation.

### IV. Systems, Articles of Manufacture and Kits

A two-component system for preparing a chlorine dioxide-containing composition is also provided. The first component comprises dry or anhydrous chlorine dioxide-generating components. The second component comprises a polar material capable of facilitating the reaction of a dry or anhydrous oxy-chlorine anion source to form chlorine dioxide. Combination of the first and second components yields a composition comprising chlorine dioxide. The chlorine dioxide-generating components optionally comprise a source of electron acceptor. In exemplary embodiments, the oxy-chlorine anion source can be sodium chlorite, and the acid source can be sodium bisulfate. In this embodiment, an exemplary optional electron acceptor is NaDCCA. In some embodiments, the chlorine dioxide-generating components are ASEPTROL® materials. Exemplary polar materials are disclosed elsewhere herein.

In an embodiment, the first component comprises dry or anhydrous chlorine dioxide-generating components, and the second component comprises a dry or anhydrous polar liquid. The resulting chlorine dioxide-containing composition can be nonaqueous.

In another embodiment, the first component comprises a water-impervious matrix, as described elsewhere herein, wherein the chlorine dioxide-generating components are dispersed or otherwise contained within the matrix. In this embodiment, the second component of the system comprises a polar material that is at least slight soluble in the water-impervious matrix. In one embodiment, the polar material does not comprise water. In this embodiment, the resulting chlorine-dioxide-comprising composition can be substantially dry or anhydrous. In another embodiment, the polar material comprises material amounts of water. In this embodiment, as described elsewhere herein, chlorine dioxide generation can be activated by the combination of the polar material and the water.

In one embodiment, the water-impervious matrix can be selected from a hydrophobic wax, a hydrophobic oil, or a mixture thereof. Exemplary waxes and oils are disclosed elsewhere herein. In exemplary embodiments, the water-impervious matrix can be one of petrolatum; a mixture of polyethylene and mineral oil and a mixture of petrolatum, paraffin wax, and mineral oil. In exemplary embodiments, the polar material can be selected from the group consisting of: glycerine, isopropanol, butyl alcohol, propylene glycol, and octanoic acid.

Also provided are devices useful for practicing the disclosed method. In one embodiment, chlorine dioxide-generating components are present in a first dispenser, such as a syringe, and a polar material is present in a second dispenser. The polar material in the second dispenser can be added directly to the chlorine dioxide-generating components in the first dispenser, the combination allowed to react to produce ClO₂, and then mixed until homogeneous. In one embodiment, the dispensers are syringes. The two syringes can be connected to each other, and the contents combined by dispensing the contents of one syringe into the other, then dispensing the mixture back into the other syringe until the mixture is homogeneous. In another embodiment, the two dispensers are the two barrels of a dual barrel syringe.

In another embodiment, chlorine dioxide-generating components, such as ASEPTROL materials, and the polar material can be retained in a dispensing unit that separates the chlorine dioxide-generating components from the polar material prior to use, and allows the two constituents to combine when dispensed. The dispensing unit can comprise a single housing unit having a separator or divider integrated with the housing so the chlorine dioxide-generating components and the polar material only meet after being dispensed from the dispensing unit. Alternatively the dispensing unit can comprise a single housing unit having a frangible separator or divider that initially separates the chlorine dioxide-generating components and polar material, but then permits the chlorine dioxide-generating components and polar material to mix when the frangible divider is penetrated. Still another variation on the dispensing unit involves a dispensing unit that holds at least two individual frangible containers, one for the chlorine dioxide-generating components and the other for the polar material; the individual frangible containers break upon the application of pressure. These and other dispensing units are fully described in U.S. Pat. No. 4,330,531 and are incorporated herein by reference in their entirety.

Further provided is a kit comprising dispensers as described above and an instructional material, which describes the preparation and use of the chlorine dioxide-containing composition. As used herein, an “instructional material,” includes a publication, a recording, a diagram, or any other medium of expression which can be used to communicate the usefulness of the composition and/or compound in a kit. The instructional material of the kit can, for example, be affixed to a container that contains the compound and/or composition or be shipped together with a container which contains the compound and/or composition. Alternatively, the instructional material can be shipped separately from the container with the intention that the recipient uses the instructional material and the compound cooperatively. Delivery of the instructional material can be, for example, by physical delivery of the publication or other medium of expression communicating the usefulness of the kit, or can alternatively be achieved by electronic transmission, for example by means of a computer, such as by electronic mail, or download from a website.

### EXAMPLES

The compositions, systems, and methods are further described in detail by reference to the following experimental examples. These examples are provided for purposes of illustration only, and are not intended to be limiting unless otherwise specified. Thus, the compositions and methods should in no way be construed as being limited to the following examples, but rather, should be construed to encompass any and all variations which become evident as a result of the teaching provided herein.

Unless otherwise indicated in the following examples and elsewhere in the specification and claims, all parts and percentages are by weight, all temperatures are in degrees Centigrade, and pressure is at or near atmospheric pressure.

### Example 1

To test whether anhydrous chlorine dioxide-generating components in a hydrophobic fluid matrix can be activated to produce chlorine dioxide by contact with a dry or anhydrous polar material, the following experiment was performed.

ASEPTROL® S-Tab 10 tablets have a high degree of conversion of chlorite anions to ClO₂ in water (see Examples in U.S. Pat. No. 6,432,322). ASEPTROL® S-Tab10 tablets were used to prepare a composition comprising chlorine dioxide-generating components in a hydrophobic fluid matrix. The chemical composition of the tablets is shown in Table 1.

TABLE 1

| Component | % (wt/wt) |
|---|---|
| Sodium chlorite | 26% |
| Dichloroisocyanuric acid, sodium salt | 7% |
| Sodium bisulfate | 26% |
| Sodium chloride | 20% |
| Magnesium chloride | 21% |

ASEPTROL® S-Tab10 tablets were prepared in a manner equivalent to that described in Example 5 of U.S. Pat. No. 6,432,322. In brief, each of the separate components of the ASEPTROL® S-Tab10 formulation was dried and mixed in the appropriate ratios. The mixture was compacted into tablet form using a hydraulic table press. The thus-formed tablets were ground into granules using a mortar and pestle. The resultant granules were screened using a 40 mesh US Standard screen; the −40 mesh size fraction was used in the experiment.

The −40 mesh size fraction was mixed with AVAGEL mineral jelly, which is a mixture of paraffin wax, petrolatum, and mineral oil). About 0.05-0.07 grams of −40 mesh granules was combined with about 7-8 grams of AVAGEL mineral jelly and mixed gently by hand using a plastic mixing rod. The resultant composition was stable and did not produce chlorine dioxide.

Samples of this matrix composition comprising ASEPTROL® granules were gently mixed by hand using a spatula for several minutes with 1-2 grams of a series of test anhydrous activators. The production of chorine dioxide was inferred by visual inspection for the development of a yellow color, which is characteristic of chlorine dioxide. The results are shown in Table 2.

TABLE 2

| | | Dielectric Constant, |
|---|---|---|
| Test Solvent | Chlorine Dioxide Formed | at 18-25 deg C. |
| Glycerine | Yes | 42.5^{†,§} |
| Butyl alcohol | Yes | 17.1-17.8^{†,§} |
| Propylene glycol | Yes | 32^{†,§} |
| Isopropanol | Yes | 18.3^{†} 20.1^{§} |
| Octanoic acid | Yes | 3.2^{†} |
| (Caprylic acid) | | |
| Oleic acid | No | 2.5^{†,§} |
| Water | No* | 80.4^{†} 78.5^{§} |

*When the composition was vigorously mixed with water, a small amount of chlorine dioxide was produced.
^{†}URL<http://www.clippercontrols.com/info/dielectric_constants.html#O>
^{§}Handbook of Chemistry and Physics, 52^{nd} Ed., 1972, pp E43-46,

These data indicate that chlorine dioxide production can be activated by a dry polar material in the absence of water, water vapor or an energy-activatable catalyst. The inability of oleic acid to activate chlorine dioxide production suggests that the relatively long carbon chain (C18) of oleic acid sufficiently diffuses or diminishes the polarity such that it is insufficiently polar to activate chlorine dioxide. Accordingly, it is believed that short carbon chains are expected to be better activators than longer carbon chains.

### Example 2

About 0.05 to 0.07 grams of −40 mesh size fraction of ASEPTROL® S-Tab 10 granules, prepared as described in Example 1, were mixed with about 7-8 grams of VASELINE petrolatum. The resulting composition was stable and did not produce chlorine dioxide. The composition was contacted with 102 grams of glycerine. Chlorine dioxide was produced, based on the production of yellow color in the mixture.

### Example 3

A quantity of −40 mesh size fraction of ASEPTROL® S-Tab 10 granules, prepared as described in Example 1, was mixed with PLASTIBASE medical ointment base in about the same ratios used in Examples 1 and 2. This matrix is a mixture of low molecular weight polyethylene (5%) and mineral oil (95%). The resulting composition was stable, and did not produce chlorine dioxide. A sample of the composition was contacted with glycerine, wherein the ratio of glycerine to the matrix/granule mixture was about the same as in Example 2. Chlorine dioxide was produced, based on the production of yellow color in the mixture.

### Example 4

A quantity of −100+200 mesh ASEPTROL® S-Tab10 granules, prepared as described in Example 1, but screened to −100+200 US Standard Screen particle size was gently mixed by hand with Pinnacle brand petrolatum in a ratio of 0.01 grams of granules per gram of petrolatum. One gram of that mixture was compacted into a first 10 ml plastic syringe having a LUER-LOK tip (BD, Franklin Lakes, N.J.). A second mixture was prepared comprising 3 grams of glycerine and 4 grams of Pinnacle brand petrolatum, and was transferred to a second 10 ml plastic syringe of the same type.

The tips of the two syringes were connected using a TEFLON® (DuPont, Wilmington, Del.) plastic LUER-LOK union, and the plunger of the second syringe was advanced to transfer the contents of the second syringe into the first syringe. The syringes were left attached, and the contents were allowed to react for 15 minutes without being disturbed. After 15 minutes the plungers of the syringes were alternately advanced to transfer the contents back and forth between the syringes 4 times. The gel was allowed to react for another 15 minutes without disturbance. The plungers of the syringes were alternately advanced to transfer and mix the contents until it was homogeneous (about 10-15 times). The resultant yellow color indicated the presence of chlorine dioxide.

The resultant plastic fluid was evaluated for cytotoxicity using the method of The United States Pharmacopeia (USP) biological reactivity limits of the Agar Diffusion Test of USP <87> “Biological Reactivity, in vitro,” (approved protocol current in 2007) and was found to be not cytotoxic.

The disclosures of each and every patent, patent application, and publication cited herein are hereby incorporated herein by reference in their entirety.

While the compositions, kits, and their methods of use have been disclosed with reference to specific embodiments, it is apparent that other embodiments and variations can be devised by others skilled in the art without departing from the true spirit and scope of the described compositions, kits, and methods of use. The appended claims are intended to be construed to include all such embodiments and equivalent variations.

What is claimed is:

1. A two-component system for preparing a chlorine-dioxide generating composition comprising one of:
a) a first component comprising a dry oxy-chlorine anion source, a dry acid source, and an optional dry electron acceptor source, and
a second component comprising a polar material,
wherein the first and second components are dry and the second component is a liquid;
b) a first component comprising a dry oxy-chlorine anion source, a dry acid source, an optional dry electron acceptor source, and a water-impervious matrix; and
a second component comprising a polar material,
wherein the first and second components are dry;
or
c) a first component comprising a dry oxy-chlorine anion source, a dry acid source, an optional dry electron acceptor source, and a water-impervious matrix; and
a second component comprising a polar material and a material amount of water,
wherein the first component is dry;
wherein combination of the first and second components yields a chlorine dioxide-generating composition.

2. The system according to claim 1, wherein the dry oxy-chlorine anion source, the dry acid source, and the optional dry electron acceptor source are in the form of a particulate precursor of chlorine dioxide.

3. The system according to claim 1, wherein the dry oxy-chlorine anion source is selected from the group consisting of an alkali metal chlorite salt, an alkaline earth metal chlorite salt, and a combination of alkali metal chlorite salts and alkaline earth metal chlorite salt.

4. The system according to claim 1, wherein the dry acid source is selected from the group consisting of inorganic acid salts, ion exchange resins, molecular sieves, and organic acids.

5. The system according to claim 1, wherein the polar material is selected from the group consisting of alcohol, organic acid, aldehyde, glycerine and combinations thereof.

6. The system according to claim 5, wherein the polar material is a dry polar liquid selected from the group consisting of: 1-10 carbon aliphatic alcohols; 2-10 carbon aliphatic aldehydes; 3-10 carbon aliphatic ketones; 1-10 carbon aliphatic carboxylic acids; esters of 1-9 carbon alcohols with 1-9 carbon acids wherein the total number of carbon atoms in the ester is 2-10; diols; ethylene glycol; diethylene glycol; triethylene glycol; tetraethylene glycol; pentaethylene glycol; propylene glycol; glycerine; acetone; acetonitrile; N,N-dimethylacetamide; N,N-dimethylformamide; dimethyl sulfoxide; hexamethylphosphoric triamide; isobutyl methyl ketone; 1-methyl-2-pyrrolidinone; nitromethane; propylene carbonate; pyridine; sulfolane; and combinations thereof.

7. The system according to claim 1, wherein the dry oxy-chlorine anion source, the dry acid source, and the optional dry electron acceptor source are a particulate precursor of chlorine dioxide contained within the water-impervious matrix.

8. The system according to claim 1, wherein the water-impervious matrix is selected from the group consisting of a hydrophobic solid, a hydrophobic fluid, and combinations thereof.

9. The system according to claim 8, wherein the hydrophobic solid is selected from the group consisting of: paraffin wax, microcrystalline wax, polyethylene wax, polypropylene wax, polyethylene glycol wax, Fischer-Tropsch wax, and combinations thereof.

10. The system according to claim 8, wherein the hydrophobic fluid is selected from the group consisting of petroleum oil, petrolatum, light mineral oil, heavy mineral oil and combinations thereof.

11. A method for producing chlorine dioxide comprising contacting a chlorine dioxide-generating composition with a dry polar material, wherein:
a) the chlorine dioxide-generating composition is dry and comprises a dry oxy-chlorine anion source, a dry acid source, and an optional dry electron acceptor source, and the polar material is a liquid;
b) the chlorine dioxide-generating composition is dry and comprises a dry oxy-chlorine anion source, a dry acid source, an optional dry electron acceptor source, and a water-impervious matrix, and the polar material is dry; or
c) the chlorine dioxide-generating composition is dry and comprises a dry oxy-chlorine anion source, a dry acid source, an optional dry electron acceptor source, and a water-impervious matrix, and the polar material comprises a material amount of water;
wherein the polar material activates production of chlorine dioxide from the chlorine-dioxide-generating composition.

12. The method according to claim 11, wherein the dry oxy-chlorine anion source, the dry acid source, and the optional dry electron acceptor source are in the form of a particulate precursor of chlorine dioxide.

13. The method according to claim 11, wherein the dry oxy-chlorine anion source is selected from the group consisting of an alkali metal chlorite salt, an alkaline earth metal chlorite salt, and a combination of alkali metal chlorite salts and alkaline earth metal chlorite salt.

14. The method according to claim 11, wherein the dry acid source is selected from the group consisting of inorganic acid salts, ion exchange resins, molecular sieves, and organic acids.

15. The method according to claim 11, wherein the dry polar material is selected from the group consisting of alcohol, organic acid, aldehyde, glycerine, and combinations thereof.

16. The method according to claim 15, wherein the dry polar material is a dry polar liquid selected from the group consisting of: 1-10 carbon aliphatic alcohols, 2-10 carbon aliphatic aldehydes, 3-10 carbon aliphatic ketones, 1-10 carbon aliphatic carboxylic acids, esters of 1-9 carbon alcohols with 1-9 carbon acids wherein the total number of carbon atoms in the ester is 2-10, diols, ethylene glycol, diethylene glycol, triethylene glycol, tetraethylene glycol, pentaethylene glycol, propylene glycol, glycerine, acetone, acetonitrile, N,N-dimethylacetamide, N,N-dimethylformamide, dimethyl sulfoxide, hexamethylphosphoric triamide, isobutyl methyl ketone, 1-methyl-2-pyrrolidinone, nitromethane, propylene carbonate, pyridine, sulfolane, and combinations thereof.

17. The method according to claim 11, wherein the dry oxy-chlorine anion source, the dry acid source, and the optional dry electron acceptor source are a particulate precursor of chlorine dioxide contained within the water-impervious matrix.

18. The method according to claim 11, wherein the water-impervious matrix is selected from the group consisting of a hydrophobic solid, a hydrophobic fluid, and combinations thereof.

19. The method according to claim 18, wherein the hydrophobic solid is selected from the group consisting of: paraffin wax, microcrystalline wax, polyethylene wax, polypropylene wax, polyethylene glycol wax, Fischer-Tropsch wax, and combinations thereof.

20. The method according to claim 18, wherein the hydrophobic fluid is selected from the group consisting of petroleum oil, petrolatum, light mineral oil, heavy mineral oil and combinations thereof.
